(19) United States
(12) Patent Application Publication
(10) Pub. No.: US 2015/0345856 A1
(43) Pub. Date: Dec. 3, 2015

(54) INTEGRATED LIGHTING SYSTEM FOR ELECTRICAL APPLIANCES, AND ELECTRICAL APPLIANCE PROVIDED WITH SAID LIGHTING SYSTEM

(71) Applicant: WHIRLPOOL S.A., Sao Paulo (BR)

(72) Inventors: Luiz Afranio Alves FERREIRA, Joinville (BR); Emerson HECK, Joinville (BR); Márcio José Espindola DEMÉTRIO, Joinville (BR)

(21) Appl. No.: 14/729,411

(22) Filed: Jun. 3, 2015

(30) Foreign Application Priority Data
Jun. 3, 2014 (BR) 10 2014 013430 1

(51) Int. Cl. F25D 27/00; F21V 14/02; F21V 33/00

(52) U.S. Cl. CPC F25D 27/00; F21V 33/0044; F21V 14/02; F21W 2131/305

(57) ABSTRACT

The present invention refers to electrical appliances and refers to a lighting system aiming to solve the technical problem of inadequate lighting apparatus of the doors of the appliances and minimize the shadow regions formed by the known lighting patterns and currently used. To this end, the invention provides a lighting system comprising at least one light source cooperating with the inner distal portion of door, said light source arranged to project spotlight at an angle comprised in the range between 90 and 120 degrees, and wherein the projection of spotlight cooperates with spotlight of light source of inner compartment of cabinet to eliminate the shadow areas arising from said light source.

### CROSS-REFERENCE TO RELATED APPLICATION

The present application claims priority to Application No. BR 10 2014 013430 1, filed in Brazil on Jun. 3, 2014, which is expressly incorporated herein in its entirety by reference thereto.

### FIELD OF THE INVENTION

The present invention refers to a lighting system for electrical appliances intended, more specifically, to the lighting of inner compartments of refrigerator appliances of household use. Therefore, in order to supply lighting also to the appliance door and minimized the shadow regions formed by known lighting patterns and currently used, the invention discloses a lighting system comprising light sources arranged at the door of the appliance, in positions and with specific directions, of totally new shape when compared with the known similar solutions.

### BACKGROUND

As is within the technical knowledge, many electrical appliances—among them it is possible to mention refrigerators, microwave ovens and cooking equipment ovens—are provided with lighting systems to facilitate the visualization of the inner compartments of the cabinets thereof.

In the more specific case of refrigerators, lighting devices are arranged, basically, in three positions: in the rear wall, on the upper surface (ceiling of the compartment) or in the side walls, as shown in appended FIGS. 1.1, 1.2, and 1.3. However, such solutions eventually generate several shadow areas inside these compartments, which can prevent adequate visualization of the stored products.

Thus, in the apparatus in which light sources 11 are located on the rear wall of inner compartment 2, shadow areas S1 are generated in the front region of the stored products and, also, in the distal portion of door 3, as can be best seen from FIG. 1.1. Document CN202118683 can be mentioned as an example of this type of lighting, to be provided with a lighting plate cooperating with the rear wall of the inner compartment thereof.

In cases where the light sources 12 are arranged in the ceiling of inner compartment 2, as illustrated in attached FIG. 1.2, it is observed shadow areas S2 in the periphery of compartment 2, in the distal portion of door 3 and, also, in the lower shelves of inner compartment 2 that do not receive direct lighting if the upper shelves are fully occupied.

In cases where light sources 13 are located in the side walls of the appliance, as shown in the attached FIG. 1.3, it is obtained the better lighting performance of the products within inner compartment 2; however there are still created shadow regions S3 in the rear portion thereof and, again, in the distal region of door 3.

Document WO2011105024 is an example of a refrigerator appliance provided with side lighting system, in conjunction to the existence of a source of backlight that is projected against a barrier coated with reflective material to project light in the back corners of the refrigerated compartment, thus eliminating the shadow areas therein.

The above solutions have the disadvantage of not providing any form of direct lighting for the products that are stored in the appliance door, what eventually affects the proper viewing thereof by the users.

An example of apparatus aiming a lighting system of door is described in document KR20130015986, in which the appliance door is articulated to an overcap provided with a LEDs blade exclusively illuminating the compartments generated by the shelves thereof. However, this solution proves to be effective only for the products stored on the appliance door, without collaborating in any way with the lighting of the inner compartment of the cabinet, therefore with the minimization of the shadow areas of the same.

Another example of the current state of the art is described in document U.S. Pat. No. 8,021,009, which describes a refrigerator appliance whose door apparatus is not capable of storing products, however it is provided with a complex system to provide lighting specifically directed to the inner compartment of the cabinet thereof.

Note, therefore, that the present state of the art lacks solutions to the technical problem of lighting of products stored in the doors of electrical appliances—especially refrigerators—and that can, simultaneously, also provide lighting to the inner region of the cabinet, thereby minimize the emergence of shadow areas which jeopardize the proper display of the stored products.

### SUMMARY

Therefore, the present invention aims to solve the technical problem of the simultaneous lighting of the compartments existing in the doors and the cabinet of electrical appliances to improve the viewing conditions of the stored products and minimize the emergence of shadow areas in the appliance as a whole, all this by means of a practical construction and low cost solution.

Thus, the main objective of the present invention is to disclose a lighting system for electrical appliances comprising at least one light source located on the appliance door and able to project, simultaneously, light to the compartments of the door itself and also for the inner compartment of the cabinet.

Moreover, it is one objective of the invention to disclose a lighting system in which the light source of the door cooperates with the lighting of the cabinet to minimize the emergence of shadow areas.

It is also another object of the invention to arrange the light source of the appliance door in such a position that will allow the achievement of the above objectives without, however, the projection of light directly into the eyes of the users.

The above mentioned objectives are achieved through an integrated lighting system for electrical appliances intended to refrigerator appliances comprising a cabinet provided with at least one inner compartment, said cabinet cooperating with at least one door comprising at least one region for storing several products.

In a preferred embodiment of the invention, said system comprises at least one light source cooperating with the inner distal portion of the door, said light source being arranged to project the spotlight at an angle comprised within the range between 90 and 120 degrees, and wherein the projection of the spotlight cooperates with the spotlight of the light source of the inner compartment of the cabinet.

Preferably said light source cooperates with the distal edge of the shoulder of the door.

Optionally said light source(s) cooperating with the appliance door comprises a rotating light source or a light source installed on a rotating support, wherein said rotating light source or light source installed on a rotating support moves in accordance with the opening degree of the door, so as to constantly project the spotlight inside the inner compartment of the cabinet.

The present invention also relates to an electrical appliance comprising the integrated lighting system as described above.

### BRIEF DESCRIPTION OF THE DRAWINGS

FIGS. 1.1, 1.2, and 1.3 illustrate schematic views of refrigerator appliances provided with lighting systems commonly used in the current state of the art, respectively with light sources arranged on the rear, upper and side surfaces of the inner compartment; and

FIG. 2 illustrates a schematic view of a refrigerator appliance comprising a preferred embodiment of the lighting system of the present invention.

### DETAILED DESCRIPTION OF THE INVENTION

The object of the present invention will be described and explained in more detail based on the accompanying drawings, which have a merely illustrative, not limitative, character, since adaptations and modifications can be made without thereby escaping from the scope of protection claimed.

The present invention relates to a lighting system for electrical appliances, specifically designed for refrigerators appliances comprising a cabinet 1 provided with one or more inner compartments 2, each one cooperating with an articulated door 3 comprising, preferably, at least one shelf or region 4 to store products.

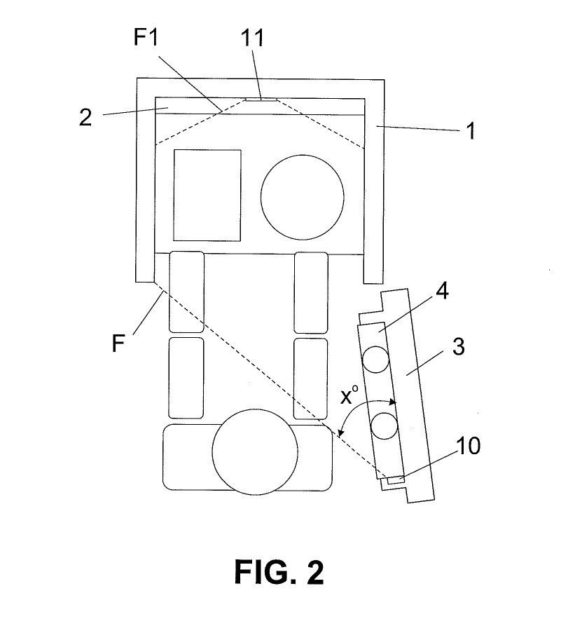

In a preferred embodiment of the invention shown in FIG. 2, said system comprises at least one light source 10 located in the inner distal portion of door 3, preferably at the distal edge of the shoulder of the door (the region of door 3 intended to the support of shelves)—that is, the outer side wall 31 delimiting the shelves or regions 4 in which it can also be stored products to be kept under refrigeration.

It is important to emphasize that said light source 10 should be positioned in such a way that when the door 3 of the appliance is fully opened, the position being shown in FIG. 2, the spotlight thereof F is projected at an angle X comprised within the range between 90 and 120 degrees relative to the inner surface of door 3, so that in addition to illuminating regions 4 of the door, said spotlight F is also capable of reaching inner compartment 2 of cabinet 1 of the appliance.

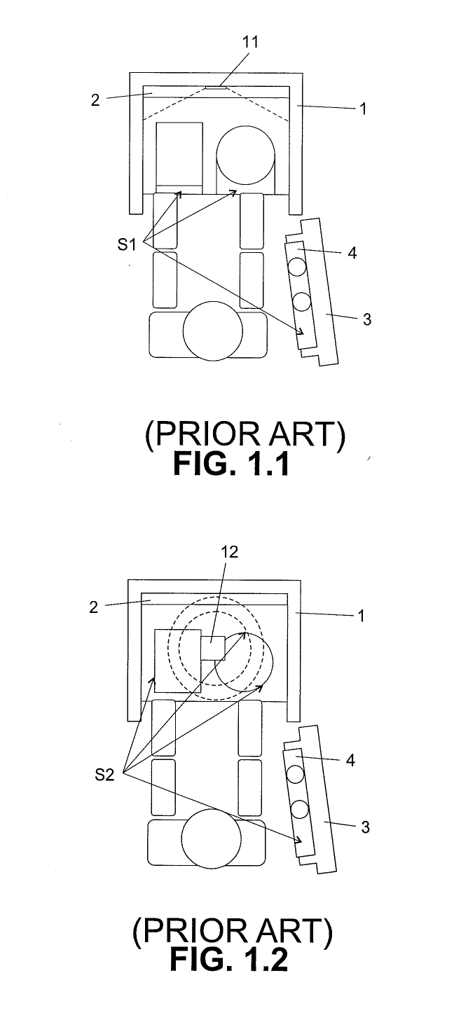

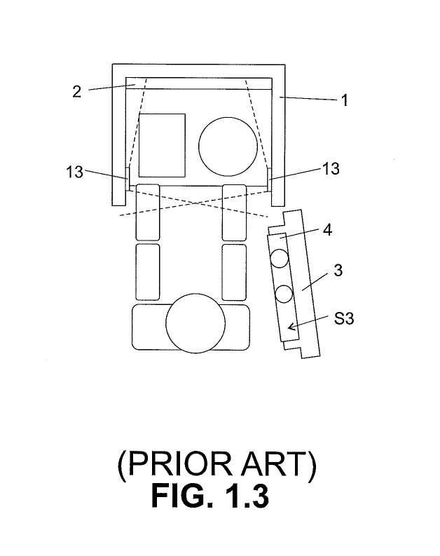

With this construction, it is noted that the spotlight F cooperates with spotlight F1 from light source 11 installed on the rear wall of inner compartment 2, thus eliminating the shadow areas originated therefrom, as it can be best seen in FIG. 1.1. An embodiment of the present invention simultaneously provides lighting for door 3 of the appliance and eliminates the shadow areas both inside inner compartment 2 when in regions 4 themselves of door 3.

It is worth to emphasize, additionally, that projection angle X of spotlight F also aims to promote the highest ability of lighting possible to door 3 and inner compartment 2 without, however, allow the light to directly focus on the eyes of the appliance user, what could cause eye discomfort and disorders.

Furthermore, also in order to provide the highest ability of possible lighting regardless the degree of opening of door 3 of the appliance, it was devised the possibility of using rotating light sources or light sources coupled to rotating supports, installed cooperatively with a controller unit or system similar to gradually rotate the light source according to the opening angle of the door, so that whatever is the degree of opening with which the appliance door 3 has been opened, light source 10 will always be projected into inner compartment 2 to eliminate shadow areas resulting from light source 11 arranged therein.

It is noted, therefore, that the object of the present invention solves the disadvantages of the current state of the art in a completely novel, practical and effective way, with a low cost of implementation and high efficiency with respect to the solution of the poor lighting problem of the products stored in the appliances doors and minimization of shadow areas in the inner compartments thereof.

Having described an example of preferred embodiment of the present invention, it is to be understood that the scope thereof contemplates other variations including all possible equivalents.

What is claimed is:

1. An integrated lighting system for an electrical appliance, including a refrigerator appliance, comprising:
a cabinet provided with at least one inner compartment, the cabinet cooperating with at least one door having at least one region for storing products;
at least one light source cooperating with an inner distal portion of the door, the light source arranged in order to project a spotlight at an angle within the range between 90 and 120 degrees;
wherein the projection of the spotlight cooperates with a spotlight of the light source of the inner compartment of the cabinet.

2. The system according to claim 1, wherein the at least one light source cooperates with a distal edge of a shoulder of the door.

3. The system according to claim 1, wherein the at least one light source cooperating with the door of the appliance includes at least one of a rotating light source or a light source installed in a rotating support.

4. The system according to claim 3, wherein the at least one of the rotating light source or the light source installed in a rotating support is adapted to move in accordance with an opening degree of door, so as to constantly project spotlight within the inner compartment of the cabinet.

5. An electrical appliance with an integrated lighting system, including a refrigerator appliance, comprising:
a cabinet provided with at least one inner compartment, the cabinet cooperating with at least one door including at least one region for storing products;
at least one light source cooperating with an inner distal portion of the door, the light source arranged in order to project a spotlight at an angle within the range between 90 and 120 degrees;
wherein the projection of the spotlight cooperates with a spotlight of the light source of the inner compartment of the cabinet.
